(19) United States
(12) Patent Application Publication
(10) Pub. No.: US 2023/0136746 A1
(43) Pub. Date: May 4, 2023

(54) METHOD AND APPARATUS FOR AUTOMATICALLY GENERATING A CALL SUMMARY

(71) Applicant: UNIPHORE TECHNOLOGIES, INC., Palo Alto, CA (US)

(72) Inventors: Maragathamani BOOTHLINGAM, Chennai (IN); Aravind GANAPATHIRAJU, Hyderabad (IN)

(21) Appl. No.: 18/089,573

(22) Filed: Dec. 28, 2022

(30) Foreign Application Priority Data
Oct. 29, 2021 (IN) 202111049780

(51) Int. Cl. G06F 40/295; H04M 3/537

(52) U.S. Cl. CPC G06F 40/295; H04M 3/537; H04M 2203/25

(57) ABSTRACT

A method and apparatus for automatically generating a call summary in call center environments is provided. The method includes identifying, from a transcript of a call between a first person and a second person, two or more consecutive mergeable turns of the first person from multiple consecutive turns of the first person, if the two or more consecutive mergeable turns of the first person are interjected by a turn of the second person. The two or more consecutive mergeable turns of the first person are merged into a single merged turn of the first person. In some embodiment, multiple entities, entity values and intents are determined, and each of multiple entity values is mapped to a corresponding entity from multiple entities. A call summary is generated based on the identified entity(ies) and corresponding entity value(s), and the identified intent(s).

### CROSS-REFERENCE TO RELATED APPLICATIONS

This application claims the benefit of the Indian Patent Application No. 202111049780, filed on Oct. 29, 2021, incorporated herein by reference.

### FIELD

The present invention relates generally to speech audio processing, and particularly to automatically generating call summary in call center environments.

### BACKGROUND

Several businesses need to provide support to its customers, which is provided by a customer care call center. Customers place a call to the call center, where customer service agents address and resolve customer issues, to satisfy the customer's queries, requests, issues and the like. The agent uses a computerized call management system used for managing and processing calls between the agent and the customer. The agent attempts to understand the customer's issues, provide appropriate resolution, and achieve customer satisfaction. The agent is required to capture the issues accurately, plan a resolution to the satisfaction of the customer, and capture a summary of the call for future record, compliance and for implementing the resolution. Despite several advances, the burden on the agents in capturing information from the call is high, and limits the ability of an agent in the number of calls handled by the agent.

Accordingly, there exists a need in the art for a method and apparatus for automatically generating call summary in call center environments.

### SUMMARY

The present invention provides a method and an apparatus for automatically generating a call summary, substantially as shown in and/or described in connection with at least one of the figures, as set forth more completely in the claims. These and other features and advantages of the present disclosure may be appreciated from a review of the following detailed description of the present disclosure, along with the accompanying figures in which like reference numerals refer to like parts throughout.

### BRIEF DESCRIPTION OF DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic depicting an apparatus for automatically generating a call summary in call center environments, in accordance with an embodiment.

FIG. 2 illustrates a method for automatically generating a call summary in call center environments, performed by the apparatus of FIG. 1, in accordance with an embodiment.

FIG. 3 illustrates a call summary generated by the method of FIG. 2, presented on a graphical user interface, in accordance with an embodiment.

### DETAILED DESCRIPTION

Embodiments of the present invention relate to a method and an apparatus for automatically generating a call summary in call center environments, for example, a call between a customer and an agent. In embodiments disclosed herein, two or more consecutive turns of a speaker that are mergeable are identified from a transcript of a conversation between two speakers. For example, if a first speaker is interrupted mid-sentence by the second speaker with filler words or repetition/confirmation or similar interruptions that do not add to the conversation, and merely interrupt the first speaker, the sentence of the first speaker is split into two turns, separated by a turn of the second speaker. Such consecutive turns of the first speaker are then merged. Further, call entities (or named entities) and call intents are extracted from the transcript, and in case of multiple entities spoken in a single turn, correct entity values are mapped to the correct entities. For example, if a speaker calls out two entity values in the same sentence, then the two values are mapped to the corresponding entities. A call summary is generated by populating a template with the identified entities, values thereof and intents. The call summary may then be sent to another device for display. The call summary may be generated in real time, that is, as soon as possible within the constraints of processing and transmission times, although deliberate delays may be induced. The call summary can also be generated in parts, that is while the call is active and progressing, with the information that is available at a given instance.

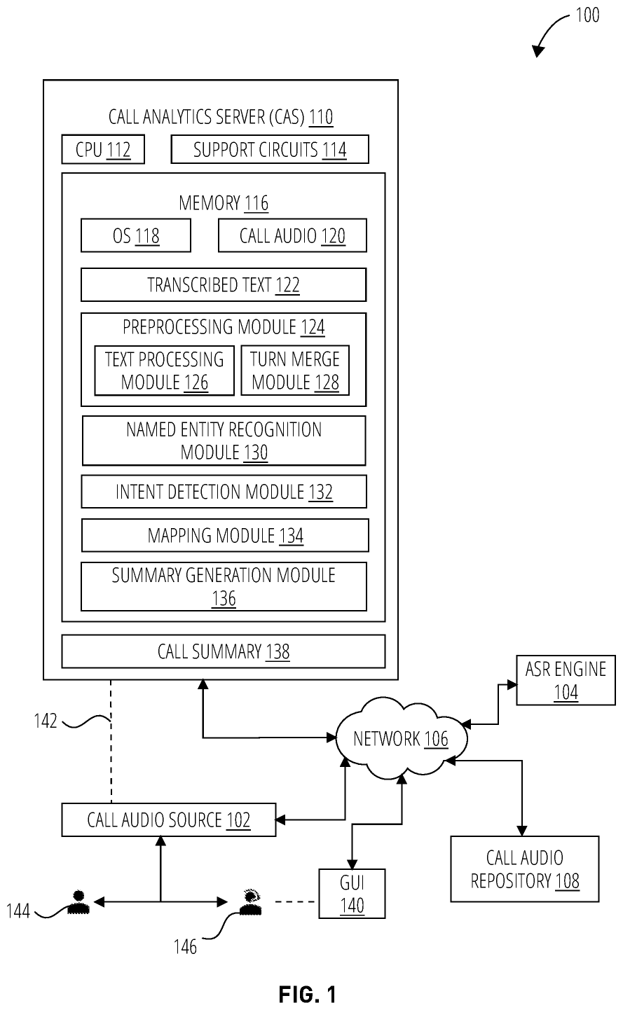

FIG. 1 is a schematic depicting an apparatus 100 for for automatically generating a call summary in call center environments, in accordance with an embodiment. The apparatus 100 comprises a call audio source 102, an ASR Engine 104, a Network 106, a Call audio repository 108, a Call analytics server (CAS) 110, and a GUI 140. The call audio source 102 is, for example, a call center to which a customer 144 of a business calls, and a customer service agent 146 representing the business.

The call audio source 102 provides audio of a call to the CAS 110. In some embodiments, the call audio source 102 is a call center providing live or recorded audio of an ongoing call between the agent 146 and the customer 144. In some embodiments, the agent 146 interacts with a graphical user interface (GUI) 140, which may be on a computer, smartphone, tablet or other such computing devices capable of displaying information and receiving inputs from the agent 146. In some embodiments, the GUI 140 is a part of the call audio source 102, and in some embodiments, the GUI 140 is communicably coupled to the CAS 110 via the Network 106.

The ASR Engine 104 is any of the several commercially available or otherwise well-known ASR Engines, as generally known in the art, providing ASR as a service from a cloud-based server, a proprietary ASR Engine, or an ASR Engine which can be developed using known techniques. ASR Engines are capable of transcribing speech data (spoken words) to corresponding text data (text words or tokens) using automatic speech recognition (ASR) techniques, as generally known in the art, and include a timestamp for some or each token(s). In some embodiments, the ASR Engine 104 is implemented on the CAS 110 or is co-located with the CAS 110.

The Network 106 is a communication network, such as any of the several communication Networks known in the art, and for example a packet data switching Network such as the Internet, a proprietary Network, a wireless GSM Network, among others. The Network 106 is capable of communicating data to and from the call audio source 102, the ASR Engine 104, the call audio repository 108, the CAS 110 and the GUI 140.

In some embodiments, the call audio repository 108 includes recorded audios of calls between a customer and an agent, for example, the customer 144 and the agent 146 received from the call audio source 102. In some embodiments, the call audio repository 108 includes training audios, such as previously recorded audios between a customer and an agent, and/or custom-made audios for training machine learning models. In some embodiments, the call audio repository 108 is located in the premises of the business associated with the call center.

The CAS 110 includes a CPU 112 communicatively coupled to support circuits 114 and a memory 116. The CPU 112 may be any commercially available processor, microprocessor, microcontroller, and the like. The support circuits 114 comprise well-known circuits that provide functionality to the CPU 112, such as, a user interface, clock circuits, network communications, cache, power supplies, I/O circuits, and the like. The memory 116 is any form of digital storage used for storing data and executable software. Such memory includes, but is not limited to, random access memory, read only memory, disk storage, optical storage, and the like. The memory 116 includes computer readable instructions corresponding to an operating system (OS) 118, a call audio 120, for example, audio of a call between a customer and an agent received from the call audio source 102 or the call audio repository 108, transcribed text 122 or transcript 122, a preprocessing module 124, a named entity recognition module NERM 130, an intent detection module IDM 132, a mapping module 134, a summary generation module SGM 136, and a call summary 138.

The preprocessing module 124 includes a text processing module TPM 126 to processes the transcribed text 122, and a turn merge module TMM 128 to merge mergeable consecutive turns, for example, prior to entity and intent recognition. The TPM 126 removes special characters (e.g., Thank you. for calling ABC travels. How can I help you?′ to ‘Thank you for calling ABC travels How can I help you’), if any, performs inverse text normalization, such as converting a word to a number (e.g., ‘my callback number is nine eight seven six five four three two one zero’ to ‘my callback number is 9876543210’), a number to a date (e.g., ‘my date of service is twenty first march twenty twenty one’ to ‘my date of service is 03/21/2021’), text to email (e.g., ‘you can send us an email at customer dot care at abc dot com’ to ‘you can send us an email at customer.care@abc.com’), and text to alphanumeric (‘the procedure code is C as in Charlie P as in Peter T as in Toronto eight seven nine’ to ‘the procedure code is CPT879’).

The TMM 128 merges consecutive turns of a speaker into a single turn based on closed vocabulary and/or comparison with filler words. Turn merging is the process of merging two or more consecutive turns of the same speaker, if the speaker's turn is interrupted by another speaker. An example of turns from a transcribed text merged based on closed vocabulary is presented below.

Customer: my call back number is nine nine six

Agent: mm hmm

Customer: seven five nine

Agent: seven five nine

Customer: four two one three

Agent: okay

Closed vocabulary method includes a predefined vocabulary related to each of numbers, months, money and date, each associated with a syntax. For example, numbers include ‘one’, ‘two’, ‘three’, and so on, money includes a currency name, for example ‘dollar’ or ‘dollars’ preceded or followed by numbers, months include ‘January’, ‘February’, ‘March’ and so on, and date includes month, date and year in different orders. If it is determined that a date is being spoken, but is incomplete, and the next turn from the same speaker completes the date, for example, according to the predefined vocabulary and syntax thereof, then it is determined that the consecutive turns of the speaker are mergeable. Accordingly, the consecutive turns of the speaker (in this example, the customer 144, are merged. In some embodiments, when certain consecutive turns of one speaker are merged, the intervening turns of the other speaker (in this example, the agent) are also merged, as shown below. In the example above, the customer 144 continues to speak predefined vocabulary type numbers in three consecutive turns, which are mergeable, and are therefore merged as shown below. Correspondingly, the intervening turns of the agent are also merged, as shown below.

Customer: my call back number is nine nine six seven five nine four two one three

Agent: mm hmm seven five nine okay

In another example of closed vocabulary, the agent 146 continues to speak a predefined vocabulary type, date, over two consecutive turns, which are mergeable.

Agent: so, the claim date will be August

Customer: August

Agent: twenty seventh twenty twenty one.

Customer: Okay

Accordingly, the agent 146 consecutive turns are merged. Further, the customer 144 is also merged because the intervening turn of the agent 146 was merged. The result of the merging is as follows.

Agent: so, the claim date will be August twenty seventh twenty twenty one.

Customer: August Okay

Closed vocabulary based turn merging addresses the issue of a single value associated with a call entity (in the examples above, the entities are a phone number and a date, respectively) spanning across multiple turns. Further, such vocabulary based merging helps maintain the entity value and its context (that is the utterance of the entity, for example, “call back number” or “claim date”) in closer proximity to the corresponding entity value.

An example of turns from a transcribed text merged based on filler words identification is presented below. In filler words based turn merging, a list of filler words is maintained, and if a speaker is interrupted by another speaker, only with any of these filler words, then the consecutive turns of the speaker on either sides of the filler words are determined as mergeable, and are merged. In some embodiments, filler words list includes ‘hmm’, ‘uhm-hmm’, ‘uh’, ‘huh’, among others. However, this list of fillers words is not exhaustive, and additional filler words may be included, for example, based on different languages, dialects, regions and/or other variations.

Agent: can I have your member

Customer: uhm-hmm

Agent: ID number please

Customer: sure its two two four five

In the example above, the customer 144 utterance ‘umm-hmm’ is the only word spoken by the customer 144 in the entire turn, and the word matches a filler word in the filler words list. Therefore, the consecutive turns of the agent 146 before and after the utterance of ‘umm-hmm’ are determined to be mergeable, and are merged as shown below.

Agent: can I have your member ID number please

Customer: sure its two two four five

While in some embodiments, the turns of the person, in this example, the customer 144 may be merged, in some embodiments, the filler words are omitted as a part of merging, for example, as shown above in the customer 144's merged turn. The filler words based turn merging helps with maintaining and not losing the context.

In this manner, the transcribed text 122 is used to generate the preprocessed text using the preprocessing module 124, and processed further to extract entities and intents.

In some embodiments, the named entity recognition module NERM 130 recognizes entities based on one or more of machine learning (ML) based named entity recognition (NER) model, a pattern-based approach, or an intent-based approach (in which a string and a free-form entity are extracted). In some embodiments, the supporting entities include person name, organization, location, date, number, percentage, money, float, alphanumeric, email, duration, time, relationship and affirmation. In some embodiments, the NERM 130 recognizes entities using techniques as known in the art. In some embodiments, when entities are recognized, values associated with the entities are also identified.

In some embodiments, intent detection module IDM 132 detects intents based on pre-configured key phrases, which are searched for in the preprocessed text by looking for an exact match of the configured key phrase(s) (exact search), or by looking for a text similar to the configured key phrases (fuzzy search), for example, using sentence similarity measure, stemming, and the like. In some embodiments, IDM 132 detects intents using techniques as known in the art.

In some embodiments, the mapping module 134 maps identified values to corresponding entities using a base mapping logic technique and/or a hybrid mapping logic technique. In some cases, the speakers may utter two entities and/or entity values in the same turn, leading to a confusion as to which value belongs to which entity, as illustrated by the example below.

Customer: Can I have my deductible and out-of pocket?

Agent: yes, the deductible is 750 dollars and out-of pocket is 200 dollars

In some embodiments, detected values are mapped to the detected entities based on a base mapping logic which includes checking if a value satisfies one or more predefined configurations for an entity, and based on a match, the value is assigned to a given entity. In some embodiments, the predefined configurations include key phrases, which specifies various ways in which an entity is identified, for example, ‘out_of pocket’, ‘out of pocket’ or ‘outof pocket’; key phrase matching channel, which specifies one speaker channel from two speakers as the valid channel from which an entity may be recognized; entity extraction channel, which specifies one speaker channel from two speakers as the valid channel from which a value may be recognized; turn, which specifies if an entity value is expected on the same pair, next pair, or previous pair of turns from where the entity is detected; entity position, which specify whether a value present as prefix or a suffix of the entity phrase is considered valid; and match type, which defines the search technique using which the entity should be matched in a transcript, for example, using an exact search or a fuzzy search (considering similar kind of key-phrases into account).

Using the base mapping logic, the outcome achieved is as follows:

Deductible—750 $, 200 $

Out-of pocket—750 $, 200 $

In the example above, multiple entities exist in a single turn, and it is unclear which of the value ‘750 dollars’ or the ‘200 dollars’ is associated with or maps to the entity ‘deductible’ and ‘out-of pocket’.

In such situations, the hybrid mapping logic is used. The hybrid mapping logic includes applying a set of conditions in a particular order or in random order, to discern which value is associated with which entity. The result of the base mapping logic is taken as an input for the hybrid mapping logic, and wherever the base logic has multiple values for the same entity, in the same turn, for example as above, the following checks are made to better identify which value should be associated with which entity. For example, a check is made if a value is mapped to an entity by the base mapping logic, then that value is not assigned to any other entity, and therefore, the set of values to be mapped is reduced. Further, if one value is assigned to an entity, say, in the above example, ‘200 $’ is mapped to ‘Out-of pocket’, then, ‘750 $’ must be mapped to ‘Deductible’. As another example, a check is made if a value and an entity are within a predefined word proximity, that is within a number of words of each other, for example, a distance of 8 words. If the value is within the predefined word proximity of an entity, then there is a higher chance of the value being associated with the entity. In the running example, ‘750$’ is within 8 words of ‘Deductible’, and is mapped thereto. As another example, a check is made if an entity is present between another entity and a value, in which case, priority is given to the entity closest to the value. One or more of the checks may be made in the order presented above or any other order to identify the entity to which a value should be associated.

In the above example, the entity ‘Out-of pocket’ is in between the entity ‘Deductible’ and value ‘200 $’, ‘Out-of pocket’ is closer to the value ‘200 $’ than ‘Deductible’, and therefore, the value ‘200 $’ is associated with the entity ‘Out-of pocket’, and the ‘750 $’ is then automatically mapped to ‘Deductible’ being the only other option. Another example of the application of hybrid mapping logic is presented.

Agent: I was looking into deductible but the oop here is 500 dollars

Here even though ‘deductible’ is the first entity, the value ‘500 dollars’ is not assigned to it, because we have another entity ‘oop’ between the ‘deductible’ and the entity value ‘500 dollars’. The mapping will therefore be:

OOP −500 $

In this manner, the entities and the values are mapped accurately, intents are identified, and used by the summary generation module SGM 136 to generate a call summary 138. The SGM 136 further post-processes the results of the previous modules to convert entities into a human readable format, for example, ‘25 dollars’ is converted to ‘$25’, ‘25 dollars and 60 cents’ to ‘$25.60’, ‘45 point 60’ to ‘45.60’, ‘50 percent’ to ‘50%’; relative dates are converted to actual dates, for example, ‘today’, ‘yesterday’, ‘next month’ or ‘last year’ and similar are converted to an actual date. The SGM 136 uses the post-processed information to generate the call summary 138 including the entities, intents, and additional information, such as the call transcript, and any other information configured therein.

The call summary 138, so generated, may then be sent for display to another device, such as a device used by the agent 146, to be displayed on a graphical user interface GUI 140.

In some embodiments, the TMM 128 and the mapping module 134 include machine learning (ML) components. For example, the closed vocabulary turn merge, the filler turn merge, satisfying the configurations of the base mapping logic, or the hybrid mapping logic checks are performed by one or more classifiers. In some embodiments, additional rules may be applied in conjunction with the ML components to ensure that the outcome of the ML components are not outside a predefined boundary condition.

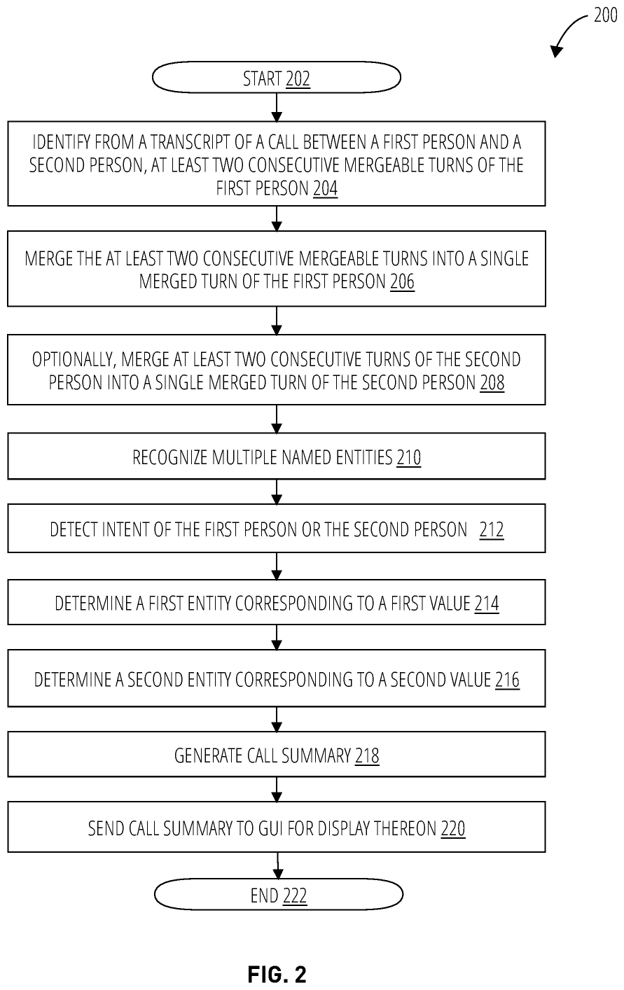

FIG. 2 illustrates a method 200 for automatically generating a call summary in call center environments, performed by the apparatus 100 of FIG. 1, in accordance with an embodiment. In particular, the method 200 is performed by the call analytics server (CAS) 110. The method 200 starts at block 202, and proceeds to block 204, at which, the method 200 identifies, from a transcribed text (e.g., the transcribed text 122) of a call between a first person and a second person, two or more consecutive mergeable turns of the first person, for example, a customer or an agent.

In some embodiments, the identifying includes a closed vocabulary method as discussed above, which includes determining if a first text in a first turn of two (or more) consecutive turns of the first person corresponds to a predefined vocabulary type, and if a second text in a second turn of the two (or more) consecutive terms of the first person corresponds to the same predefined vocabulary type. If the text in two (or more) consecutive terms correspond to the predefined vocabulary type, then the block 204 determines that the first turn and a second turn consecutive to the first turn are mergeable. In some embodiments, the predefined vocabulary type includes, without limitation, a number, a month, a sum of money, or a date, and syntax of how such predefined vocabularies are presented. For example, a date may be presented in month, date and year, or date, month and year, or several other syntaxes as known in the art.

In some embodiments, the identifying includes a filler list based method as discussed above, which includes comparing a turn of the second person to a list of filler words, and if it is determined that the turn of the second person includes filler word(s) only, then it is determined that a first turn and a second turn of the first person separated by this turn of the second person are mergeable. In this manner, the mergeable turns are identified at block 204, for example, according to the closed vocabulary and/or the filler word based methods discussed above.

At block 206, the method 200 merges the at least two consecutive mergeable turns into a single merged turn of the first person, and at block 208, the method 200 may optionally merge at least two consecutive turns of the second person into a single merged turn of the second person.

At block 210, the method 200 recognizes multiple named entities, and at block 212, the method 200 detects intent of the first person or the second person from the transcribed text of the conversation between the first person and the second person.

At block 214, the method 200 identifies a first entity and a first value from multiple values in a turn of a (first or second) speaker. The method 200 matches the first entity to the first value based on at least one of key phrase matching, key phrase matching channel, entity extraction channel, turn, entity position with respect to the entity key phrase, or a match type, and determines that the first entity corresponds to the first value based on the matching of the first entity to the first value, for example as discussed above with respect to base mapping logic.

At block 216, the method identifies a second entity and a second value from the multiple values that are also in the same turn as the first entity and the first value. The method 200 matches the second entity to the second value based on at least one of key phrase matching, key phrase matching channel, entity extraction channel, turn, entity position with respect to the entity key phrase, or a match type. In some embodiments, however the method 200 determines that the second entity corresponds to the second value based on a determination that the first entity corresponds to the first value, the second entity is within a predefined proximity of the second value, or proximity of the second entity to the second value compared to the proximity of the first entity to the second value, for example, as discussed above with respect to the hybrid mapping logic.

At block 218, the method 200 generates a call summary, for example, the call summary 138. The call summary 138 includes one or more of the single merged turn of the first person, the single merged turn of the second person, the first entity and the first value, or the second entity and the second value.

At block 220, the method 200 sends the call summary 138 to a user device for display on a graphical user interface (GUI). In some embodiments, at least a portion of the call summary is sent to the user device for display on the GUI in real time, and in some embodiments, at least a portion of the call summary is sent to the user device for display on the GUI while the call is active. In some embodiments, a deliberate delay may be introduced at one or more steps, including performing the method 200 after the call is concluded, and all such variations are contemplated within the method 200.

The method 200 proceeds to block 222, at which the method 200 ends.

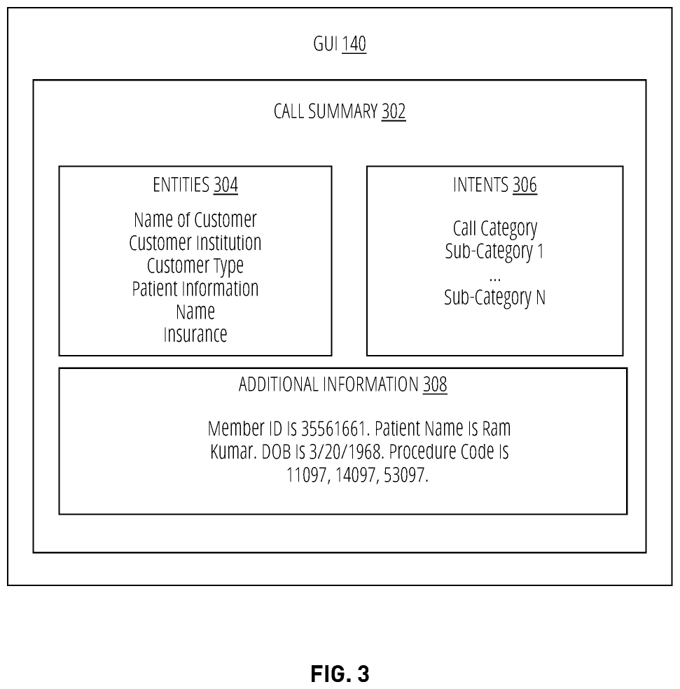

FIG. 3 depicts a call summary 302 displayed in the GUI 140 of the user device accessible to the agent 146. In some embodiments, the call summary 302 is the call summary 138 generated at the block 218 of method 200, and sent to the user device at block 220 for being presented on the GUI 140. The call summary 302 comprises entities 304, intents 306, and additional information 308 as may be configured therein.

While audios have been described with respect to call audios of conversations in a call center environment, the techniques described herein are not limited to such call audios. Those skilled in the art would readily appreciate that such techniques can be applied readily to any audio containing speech, including single party (monologue) or a multi-party speech.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations, and data stores are somewhat arbitrary, and particular operations are illustrated in the context of specific illustrative configurations. Finally, structures and functionality presented as discrete components in the example configurations may be implemented as a combined structure or component. These and other variations, modifications, additions, and improvements may fall within the scope of embodiments as described.

While the foregoing is directed to embodiments of the present invention, other and further embodiments of the invention may be devised without departing from the basic scope thereof.

I/We claim:

1. A method for automatically generating a call summary, the method comprising:
identifying, at a call analytics server (CAS), from a transcript of a call between at least two persons comprising a first person and a second person, at least two consecutive mergeable turns of the first person from a plurality of consecutive turns of the first person, the at least two consecutive mergeable turns of the first person being interjected by at least one turn of the second person,
wherein a turn corresponds to transcribed text of continuous speech of the first person or the second person, uninterrupted by the second person or the first person, respectively; and
merging, at the CAS, the at least two consecutive mergeable turns of the first person into a single merged turn of the first person.

2. The method of claim 1, wherein the identifying comprises:
determining a first text in a first turn of the at least two consecutive turns of the first person corresponds to a predefined vocabulary type;
determining a second text in a second turn of the at least two consecutive terms of the first person corresponds to the predefined vocabulary type; and
determining that the first turn and a second turn consecutive to the first turn are mergeable.

3. The method of claim 2, wherein a predefined vocabulary type comprises one of a number, a month, a sum of money, or a date, and syntax thereof.

4. The method of claim 1, wherein the identifying comprises:
comparing the at least one turn of the second person to a list of filler words;
determining that the at least one turn of the second person comprises filler word(s) only; and
determining that a first turn and a second turn of the first person separated by the at least one turn of the second person are mergeable.

5. The method of claim 1, wherein the at least one turn of the second person comprises at least two consecutive turns of the second person that are separated by at least one of the at least two consecutive mergeable turns of the first person, the method further comprising:
merging, at the CAS, the at least two consecutive turns of the second person into a single merged turn of the second person.

6. The method of claim 1, further comprising performing, at the CAS, at least one of entity recognition to identify a plurality of entities in the transcript, or intent detection to identify at least one intent of the first person or the second person or both.

7. The method of claim 6, further comprising:
identifying, at the CAS, a first entity and a first value from the plurality of values, wherein the first entity and the first value are comprised in a third turn of the first speaker;
matching, at the CAS, the first entity to the first value based on at least one of key phrase matching, key phrase matching channel, entity extraction channel, turn, entity position with respect to the entity key phrase, or a match type; and
determining, at the CAS, that the first entity corresponds to the first value based on the matching of the first entity to the first value.

8. The method of claim 7, further comprising:
identifying, at the CAS, a second entity and a second value from the plurality of values, wherein the second entity and the second value are comprised in the third turn;
matching, at the CAS, the second entity to the second value based on at least one of key phrase matching, key phrase matching channel, entity extraction channel, turn, entity position with respect to the entity key phrase, or a match type; and
determining, at the CAS, that the second entity corresponds to the second value based on at least one of:
determination that the first entity corresponds to the first value,
the second entity being within a predefined proximity of the second value, or
proximity of the second entity to the second value compared to the proximity of the first entity to the second value.

9. The method of claim 8, further comprising generating, at the CAS, a call summary comprising at least one of the single merged turn of the first person, the single merged turn of the second person, the first entity and the first value, or the second entity and the second value.

10. The method of claim 9, further comprising sending the call summary, from the CAS to a user device remote to the CAS, for display on a graphical user interface (GUI) of the user device.

11. The method of claim 10, wherein at least a portion of the call summary is sent to the user device for display on the GUI in real time.

12. The method of claim 11, wherein at least a portion of the call summary is sent to the user device for display on the GUI while the call is active.

13. A method for generating a call summary, the method comprising:
performing, at a call analytics server (CAS), from a transcript of a call between at least two persons comprising a first person and a second person, at least one of entity recognition to identify a plurality of entities in the transcript, or intent detection to identify at least one intent of the first person or the second person or both;
identifying, at the CAS, a first entity and a first value from the plurality of values, wherein the first entity and the first value are comprised in a first turn of the first person;
matching, at the CAS, the first entity to the first value based on at least one of key phrase matching, key phrase matching channel, entity extraction channel, turn, entity position with respect to the entity key phrase, or a match type; and
determining, at the CAS, that the first entity corresponds to the first value based on the matching of the first entity to the first value.

14. The method of claim 13, further comprising:
identifying, at the CAS, a second entity and a second value from the plurality of values, wherein the second entity and the second value are comprised in the first turn;
matching, at the CAS, the second entity to the second value based on at least one of key phrase matching, key phrase matching channel, entity extraction channel, turn, entity position with respect to the entity key phrase, or a match type; and
determining, at the CAS, that the second entity corresponds to the second value based on at least one of:
determination that the first entity corresponds to the first value,
the second entity being within a predefined proximity of the second value, or
proximity of the second entity to the second value compared to the proximity of the first entity to the second value.

15. The method of claim 14, further comprising generating, at the CAS, a call summary comprising at least one of the first entity and the first value, or the second entity and the second value.

16. A computing apparatus comprising:
a processor; and
a memory storing instructions that, when executed by the processor, configure the apparatus to:
identify, at a call analytics server (CAS), from a transcript of a call between at least two persons comprising a first person and a second person, at least two consecutive mergeable turns of the first person from a plurality of consecutive turns of the first person, the at least two consecutive mergeable turns of the first person being interjected by at least one turn of the second person,
wherein a turn corresponds to transcribed text of continuous speech of the first person or the second person, uninterrupted by the second person or the first person, respectively; and
merge, at the CAS, the at least two consecutive mergeable turns of the first person into a single merged turn of the first person.

17. The computing apparatus of claim 16, wherein the identifying comprises:
determine a first text in a first turn of the at least two consecutive turns of the first person corresponds to a predefined vocabulary type;
determine a second text in a second turn of the at least two consecutive terms of the first person corresponds to the predefined vocabulary type; and
determine that the first turn and a second turn consecutive to the first turn are mergeable,
wherein a predefined vocabulary type comprises one of a number, a month, a sum of money, or a date, and syntax thereof.

18. The computing apparatus of claim 16, wherein the identifying comprises:
compare the at least one turn of the second person to a list of filler words;
determine that the at least one turn of the second person comprises filler word(s) only; and
determine that a first turn and a second turn of the first person separated by the at least one turn of the second person are mergeable.

19. The computing apparatus of claim 16, wherein the instructions further configure the apparatus to:
perform, at the CAS, at least one of entity recognition to identify a plurality of entities in the transcript, or intent detection to identify at least one intent of the first person or the second person or both;
identify, at the CAS, a first entity and a first value from the plurality of values, wherein the first entity and the first value are comprised in a third turn of the first speaker;
match, at the CAS, the first entity to the first value based on at least one of key phrase matching, key phrase matching channel, entity extraction channel, turn, entity position with respect to the entity key phrase, or a match type; and
determine, at the CAS, that the first entity corresponds to the first value based on the matching of the first entity to the first value.

20. The computing apparatus of claim 19, wherein the instructions further configure the apparatus to:
identify, at the CAS, a second entity and a second value from the plurality of values, wherein the second entity and the second value are comprised in the third turn;
match, at the CAS, the second entity to the second value based on at least one of key phrase matching, key phrase matching channel, entity extraction channel, turn, entity position with respect to the entity key phrase, or a match type; and
determine, at the CAS, that the second entity corresponds to the second value based on at least one of:
determination that the first entity corresponds to the first value,
the second entity being within a predefined proximity of the second value, or
proximity of the second entity to the second value compared to the proximity of the first entity to the second value.
